(19) United States
(12) Patent Application Publication
(10) Pub. No.: US 2013/0098717 A1
(43) Pub. Date: Apr. 25, 2013

(54) INTERNALLY VENTILATED BRAKE DISK

(71) Applicant: AUDI AG, Ingolstadt (DE)

(72) Inventor: Christopher Hantschke, Gaimersheim (DE)

(73) Assignee: AUDI AG, Ingolstadt (DE)

(21) Appl. No.: 13/654,075

(22) Filed: Oct. 17, 2012

(30) Foreign Application Priority Data
Oct. 21, 2011 (DE) 10 2011 116 601.0

(51) Int. Cl. F16D 65/12; F16D 65/847

(52) U.S. Cl. 188/218 XL

(57) ABSTRACT

An internally ventilated brake disk includes friction rings arranged on both sides of the brake disk. Each friction ring has a friction surface and perforated segments and unperforated segments arranged between the perforated segments. Each friction surface engages with a base surface of a brake pad during braking. The brake disk further includes cooling channels extending between the friction surfaces and leading to cooling channel openings disposed on a peripheral edge of the brake disk, and through-holes arranged in the friction rings and extending from the friction surfaces to the cooling channels. The through-holes in a perforated segment are distributed in the friction surface of the perforated segment, and the friction surface of an unperforated segment extends at least over half the base surface of a contacting brake pad.

### CROSS-REFERENCES TO RELATED APPLICATIONS

This application claims the priority of German Patent Application, Serial No. 10 2011 116 601.0, filed Oct. 21, 2011, pursuant to 35 U.S.C. 119(a)-(d), the content of which is incorporated herein by reference in its entirety as if fully set forth herein.

### BACKGROUND OF THE INVENTION

The present invention relates to an internally ventilated brake disk.

The following discussion of related art is provided to assist the reader in understanding the advantages of the invention, and is not to be construed as an admission that this related art is prior art to this invention.

Internally ventilated brake disks with cooling channels formed between two friction rings are known in the art. An increasing rotation speed causes correspondingly high airflow velocities in the cooling channels, thereby cooling the brake disk. Brake dust produced on the friction surfaces of the friction ring of an internally ventilated brake disk may be suctioned via the cooling channels. It has also been proposed to form grooves with incorporated through-slots in the friction surfaces of the friction rings. The through-slots extend to the cooling channels formed between the friction rings, whereby the brake dust can be suctioned from the area of the friction surfaces via these slots and due to the vacuum in the cooling channels. In this conventional brake disk, the grooves with the incorporated through-slots are uniformly distributed across the friction surfaces, so that a brake shoe is always in contact with a grooved friction surface during the braking process. These grooved friction surfaces require higher brake pressure compared to non-grooved friction surfaces in order to attain an equivalent braking effect. In addition, attaining uniform wear of the brake pad is a problem with such brake disks, and acoustic problems may also occur.

It would therefore be desirable and advantageous to obviate prior art shortcomings and to provide an improved internally ventilated brake disk with through-holes for suctioning brake dust, which also has optimal braking properties.

### SUMMARY OF THE INVENTION

According to one aspect of the present invention, an internally ventilated brake disk includes friction rings arranged on both sides of the brake disk, each friction ring having a friction surface and perforated segments and unperforated segments arranged between the perforated segments, with each friction surface engaging with a base surface of a brake pad during braking. The brake disk further includes cooling channels extending between the friction surfaces and leading to cooling channel openings disposed on a peripheral edge of the brake disk, and through-holes arranged in the friction rings and extending from the friction surfaces to the cooling channels. The through-holes in a perforated segment are distributed in the friction surface of the perforated segment, and the friction surface of an unperforated segment extends at least over half the base surface of a contacting brake pad.

Stated differently, the two opposing friction rings of the brake disk are divided into perforated segments and unperforated segments, wherein the perforated segments have through-holes distributed in the segment surface and extending to the cooling channels. In the unperforated segments disposed between the perforated segments, the two opposing brake pads can attain with their base surfaces a correspondingly high braking effect. According to the invention, the segment surface of an unperforated segment then extends at least over half the base surface of a contacting brake pad. When a perforated segment passes the base surface of the brake pad, the brake dust is almost completely suctioned off across the entire surface, because the through-holes are distributed over the surface of the perforated segments.

The internally ventilated brake disk according to the present invention makes it possible to suction the generated brake dust over the entire surface and to eject the generated brake radially through the cooling channels in the direction of the rim bed, thereby preventing contamination on the rim pockets and/or rim spokes visible from the outside. Each of the unperforated segments is preferably sized so as to maximally cover the entire base surface of a contacting brake pad, so that the generated brake dust is suctioned as completely as possible.

According to an advantageous feature of the present invention, the mechanical stability of the brake disk may be increased by arranging one or several blind holes in the friction surface in the outer and inner edge region of the perforated segments while eliminating through-holes. Arranging the blind holes in the edge regions not only increases the stability, but allows the brake dust to be captured in the edge regions in the blind holes and to agglomerate. A portion of the captured brake dust is suctioned out of the holes toward the brake disk surface, when the brake pad passes over the holes, and is subsequently thrown radially outwardly by the centrifugal force toward the rim bed. This effect is particularly pronounced when the blind holes are arranged in the outermost edge region of the friction surfaces.

According to another advantageous feature of the present invention, the holes in the friction surfaces of the friction rings may be distributed with rotational symmetry, so that the holes in each perforated segment are identically distributed within the segment surface. However, the holes may advantageously also be distributed in each perforated segment with a slight offset in relation to the other perforated segments, so as to ensure for example that through-holes have passed over the entire base surface of the brake pad during an entire revolution of the brake disk. With this approach, a smaller number of through-holes or smaller through-holes are then able to completely cover the base surface of the friction pad during one revolution of the brake disk than when using perforated segments where the through-holes have identical positions.

According to another advantageous feature of the present invention, the perforated and unperforated segments may cover approximately identically-sized partial circular areas of the friction surfaces, resulting in a corresponding symmetric load on the brake disk and also uniform suctioning of the brake dust. The friction surfaces of the two friction rings may advantageously have three perforated segments; however, four or more perforated segments may be provided. Four perforated segments and four unperforated segments may be provided in particular for larger brake disks.

According to another advantageous feature of the present invention, the holes in one segment may form two or more straight or curved rows of holes which are arranged sequentially in the rotation direction of the brake disk and are oriented at an angle with respect to the radial direction. The through-holes of each row of holes then preferably lead to different cooling channels, so that maximum suction power is attained at each through-hole due to the vacuum in the associated cooling channel.

According to another advantageous feature of the present invention, the holes within a perforated segment may be arranged with an offset in the circumferential direction and are thus located on different orbits. This optimizes the suction effect on the base surface of the friction pad.

Advantageously, the holes within a segment may be offset such that the holes traverse at least approximately the entire base surface of a contacting brake pad during the braking process. The brake dust on the brake pad can thus be completely suctioned multiple times during one complete revolution of the brake disk.

According to another advantageous feature of the present invention, the paths of the holes of a segment may advantageously be arranged on involutes to ensure the desired suction effect of the brake dust and minimize adverse effects on the brake effect. The involute formed by a row of holes may advantageously be inclined with respect to the radial direction in an angular range from about 40° to 60°.

According to another advantageous feature of the present invention, a plowing effect caused by the brake pads at the hole edges can be reduced by providing each of the holes on the friction surface with a chamfer.

According to another advantageous feature of the present invention, the through-holes may also be arranged inside grooves oriented at an angle with respect to the rotation direction of the brake disk, wherein groove edges may advantageously also be chamfered to prevent a plowing effect with respect to the contacting brake pad.

According to another advantageous feature of the present invention, the perforated and unperforated segments of one friction ring may be arranged, as viewed in the circumferential direction of the friction ring, substantially at approximately the same height as on the other friction ring. According to another advantageous embodiment of the present inventive concept, the perforated segments of one friction ring may preferably be offset, as viewed in the circumferential direction of the friction ring, with respect to the unperforated segments of the other friction ring, with the unperforated segments of the one friction ring then inevitably also arranged with an offset in the circumferential direction of the friction ring in relation to the unperforated segments of the other friction ring. According to another advantageous feature of the present invention, the suction effect per cooling channel can once more be substantially increased by arranging the segments with an at least partial offset in relation to the two facing sides of the friction rings of the brake disk. This situation occurs in particular when a perforated segment of one friction ring, as viewed in the axial direction of the brake disk, more or less directly faces an unperforated segment of the other friction ring, thereby producing a particularly effective suction effect. The friction value generated over the revolution of the brake disk can also be further enhanced by the aforedescribed measures. According to another advantageous feature of the present invention, a perforated segment of a cup-side friction ring may face an unperforated segment in a front-side friction ring.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a simplified side view of a brake disk according to the present invention in contact with a brake pad,

FIG. 2 is a three-dimensional representation of an internally ventilated brake disk with perforated and unperforated segments,

FIG. 3 shows the brake disk of FIG. 2 in a front view, and

FIG. 4 is a cross-sectional view of the brake disk of FIG. 2 in the region of a cooling channel.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to the drawing, and in particular to FIG. 1, there is shown a simplified diagram of an internally ventilated brake disk 1 with a friction ring 4 divided into perforated segments 2 and unperforated segments 3. A brake pad 6 contacts the visible friction surface 5 of the friction ring 4 with its obscured base surface 7 during the braking process. A likewise obscured facing brake pad is in contact with the obscured rear friction ring of the brake disk 1. The base surface 7 is located almost entirely within an unperforated segment 3 so as to attain a maximum braking force. When the brake disk continues to rotate in the rotation direction 8, the holes 9 of the segment 2 rotating underneath the brake pad 6 pass the base region 7 of the brake pad 6. For sake of simplicity, only some of the holes are labeled with the reference symbol 9. The other perforated segments 2 have corresponding holes which can be formed as through-holes 10.

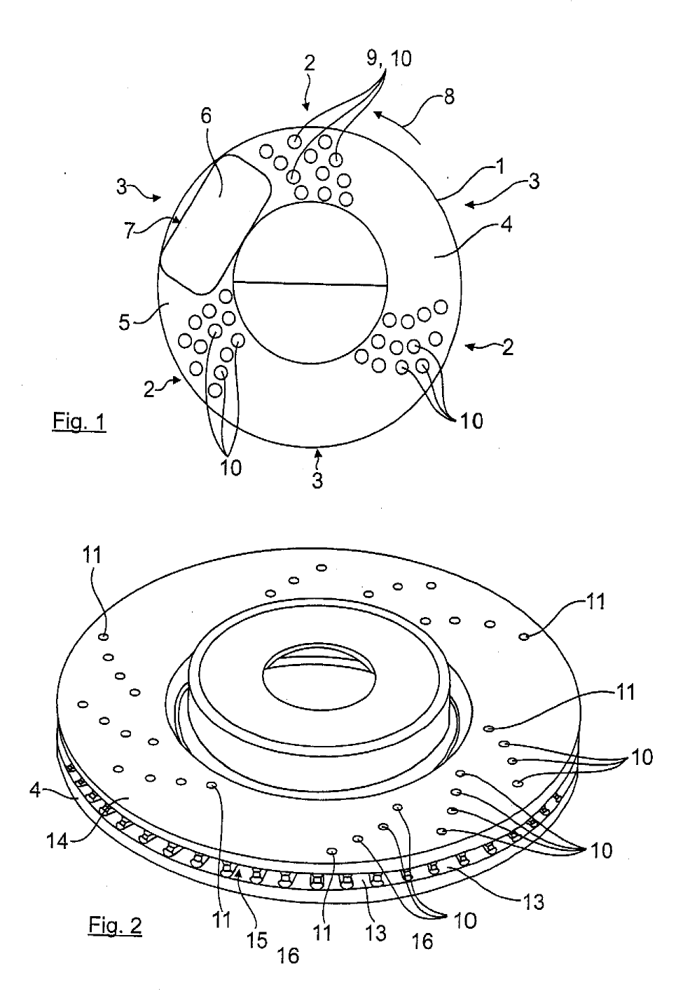

The holes arranged on the inner and outer edge of the friction ring 4 may be formed as blind holes 11 to provide stability, as indicated in FIG. 2. The other holes in FIG. 2 that are not labeled with the reference symbol 11 may be formed as through-holes 10, wherein each of the through-holes leads to a cooling channel 13. The plurality of the cooling channels 13 extends in the illustrated exemplary embodiment in the radial direction between the upper friction ring 14 and the lower friction ring 4. When the brake disk 1 rotates, a vacuum is produced in the cooling channels 13 which causes brake dust to be suctioned via the through-holes 10. The brake dust is suctioned from the base surface 7 (see FIG. 1) of the brake pad 6 via the through-holes 10 into the cooling channels 13 and is ejected from the cooling channel openings 15 in the radial direction due to the centrifugal force. To ensure suction over the greatest possible area on the base surface 7 of the brake pad 6, the through-holes of a segment 2 are arranged on different radii. The through-holes within a segment 2 are thus arranged with an offset in the rotation direction. The same applies to the blind holes 11, because these are also configured to receive brake dust.

The cooling channels 13 are separated from each other by lands 16, via which the friction rings 4, 14 are connected with one another.

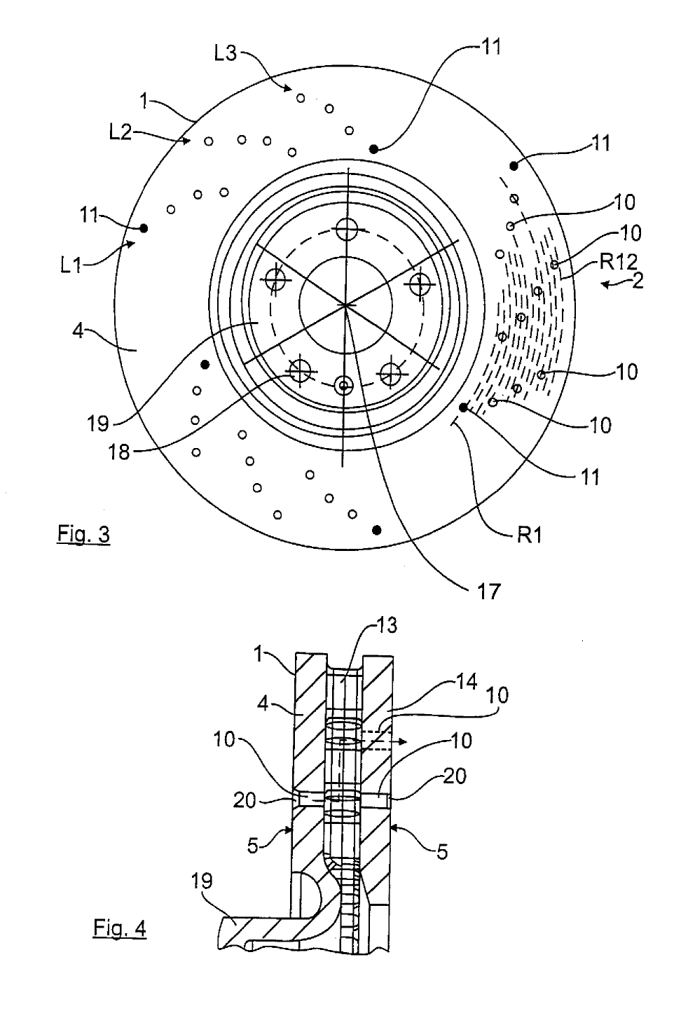

FIG. 3 shows the front view of the brake disk of FIG. 2, illustrating in particular the radial distribution of the blind holes 11 and the through-holes 10. The perforated segment 2 illustrated on the right side shows in form of broken lines different circular orbits R1 to R12, which have different radial distances from the center axis 17 of the brake disk 1. It is evident that each of the through-holes 10 and the blind holes 11 of the perforated segment 2 has a different radial distance from the center axis 17. This produces a two-dimensional distribution of the holes 10, 11 such that the holes 10, 11 traverse the entire base surface 7 (see FIG. 1) during the braking process, thereby ensuring removal of the brake dust over the entire area predominantly through suctioning of the brake dust.

The holes 10, 11 within a perforated segment form three curved rows of holes L1 to L3 arranged consecutively in the rotation direction 8 of the brake disk 1, which are oriented preferably in an angular range of approximately 40° to 60° with respect to the radial direction.

FIG. 3 also shows attachment holes 18 in the region of an attachment flange 19 of the brake disk 10.

FIG. 4 shows a partial cross-section through the brake disk 1 of FIG. 2 in the region of a radially oriented cooling channel 13, illustrating through-holes 10 which are each arranged in the two opposing friction rings 4, 14 and which extend from the associated friction surfaces 5 to the cooling channels 13. The through-holes 10 are implemented as through-bores and have a chamfer at the edge of the hole in the region of the friction surface 5.

As only schematically indicated in FIG. 4, the through-holes and hence the perforated segments 2 and the unperforated segments 3 may be each arranged on the two friction rings 4, 14, as viewed in the circumferential direction of the brake disk, at approximately the same height. Alternatively, which is indicated in FIG. 4 only very schematically and by dashed lines, the perforated segments 2 of the preferably cup-side friction ring 4 may be arranged, as viewed in the circumferential direction of the friction ring, with an offset in relation to the perforated segments 2 of the other friction ring 14, whereby the unperforated segments 3 of the one friction ring are then necessarily also arranged with an offset in the circumferential direction of the friction ring in relation to the unperforated segments 3 of the other friction ring. As again only schematically indicated in FIG. 4 by the flow arrow in form of a dashed line, the flow is then guided along an extended path with offset into the image plane, producing an optimal suction effect.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An internally ventilated brake disk, comprising:
friction rings arranged on both sides of the brake disk, each friction ring having a friction surface and perforated segments and unperforated segments arranged between the perforated segments, with the friction surface engaging with a base surface of a brake pad during braking,
cooling channels extending between the friction surfaces and leading to cooling channel openings disposed on a peripheral edge of the brake disk,
through-holes arranged in the friction rings and extending from the friction surfaces to the cooling channels,
wherein the through-holes in a perforated segment are distributed over the friction surface of the perforated segment, and the friction surface of an unperforated segment extends at least over half the base surface of a contacting brake pad.

2. The brake disk of claim 1, wherein each unperforated segment is dimensioned so as to maximally cover the entire base surface of a contacting brake pad.

3. The brake disk of claim 1, wherein an outer and an inner edge region of a perforated segment each are free from through-holes and comprise at least one blind hole disposed in the friction surface.

4. The brake disk of claim 3, wherein the through-holes and the at least one blind hole are arranged such that the through-holes holes and the at least one blind hole holes completely cover the base surface of the engaging brake pad at least during a complete revolution of the brake disk.

5. The brake disk of claim 3, wherein the through-holes and the at least one blind hole are arranged in the friction surfaces with rotational symmetry.

6. The brake disk of claim 1, wherein the perforated and the unperforated segments cover partially circular areas of the friction surfaces of approximately identical size.

7. The brake disk of claim 1, wherein the friction surface of a friction ring comprises three or four perforated segments.

8. The brake disk of claim 3, wherein the through-holes and the at least one blind hole of a perforated segment form two or more straight or curved rows of holes arranged consecutively in a rotation direction of the brake disk, with the rows of holes being inclined with respect to a radial direction of the brake disk.

9. The brake disk of claim 9, wherein the rows of holes are inclined in an angular range of approximately 40° to 60°.

10. The brake disk of claim 3, wherein the through-holes and the at least one blind hole within a perforated segment are arranged with an offset at different radial distances from a center axis of the brake disk.

11. The brake disk of claim 10, wherein a totality of the through-holes and the at least one blind hole traverses at least approximately the entire base surface of a contacting brake pad during braking.

12. The brake disk of claim 8, wherein the rows of holes are located on involutes.

13. The brake disk of claim 3, wherein each of the through-holes and the at least one blind hole has a chamfer.

14. The brake disk of claim 1, wherein the through-holes are disposed inside grooves oriented at an angle in relation to a rotation direction of the brake disk and having chamfered edges.

15. The brake disk of claim 1, wherein each through-hole leads to a separate cooling channel.

16. The brake disk of claim 1, wherein the perforated segments of one friction ring are arranged, as viewed in a circumferential direction of the friction ring, with an offset in relation to the perforated segments of another friction ring, and wherein the unperforated segments of the one friction ring are then also arranged, as viewed in the circumferential direction of the friction ring, with an offset in relation to the unperforated segments of the other friction ring.

17. The brake disk of claim 16, wherein a perforated segment of one friction ring faces, as viewed in an axial direction of the brake disk, an unperforated segment of the other friction ring.

18. The brake disk of claim 17, wherein an unperforated segment of an end-side friction ring at least partially faces a perforated segment of a cup-side friction ring.
